(19) United States
(12) Patent Application Publication
(10) Pub. No.: US 2003/0075614 A1
(43) Pub. Date: Apr. 24, 2003

(54) Valve assembly, in particular for a fuel injection system of an internal combustion engine

(76) Inventors: Stefan Schuerg, Ludwigsburg (DE); Otto SImon, Oberhaid (DE); Udo Lux, Baunach (DE); Wolfgang Stoecklein, Stuttgart (DE); Roland Stoecklein, Buttenheim (DE); Guenther Weissenberger, Viereth-Trunstadt (DE); Georg Fleischmann, Pretzfeld (DE); Thomas Koeppel, Oberhaid (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/088,901

(22) PCT Filed: May 25, 2001
(86) PCT No.: PCT/DE01/02029

(30) Foreign Application Priority Data
Aug. 1, 2000 (DE) 100 37 388.7

(51) Int. Cl. B05B 1/08

(52) U.S. Cl. 239/102.1

(57) ABSTRACT

A valve assembly suitable in particular for a fuel injection system of an internal combustion engine is proposed, which includes an adjustably disposed valve element, an actuator unit, in particular a piezoelectric actuator unit, for adjusting the valve element, and a hydraulic force transmission chamber disposed in the force transmission path between the actuator unit and the valve element. For diverting at least one hydraulic filling stream, to be delivered to the force transmission chamber for filling it, from a hydraulic mainstream, a hydraulic pressure distributor assembly (50b, 52b) is provided, which has a conduit system (46b, 48b) that is embodied in a conduit housing (14b) and has both a main conduit (46b), carrying the hydraulic mainstream, and at least one filling conduit (48b), branching off from the main conduit (46b) and carrying the hydraulic filling stream. The pressure distributor assembly (50b, 52b) forms one hydraulic throttling region (50b, 52b) for the hydraulic mainstream each on both sides of the branching point of the filling conduit (48b) from the main conduit (46b). At least one of the throttling regions (50b, 52b) is embodied as a throttle bore.

### PRIOR ART

The invention relates to a valve assembly, in particular for a fuel injection system of an internal combustion engine.

In the industry, valve assemblies are known in which a hydraulic force transmission chamber is disposed in the force transmission path between a valve element and an actuator unit serving to adjust it; this force transmission chamber makes it possible, without transmitting force, to compensate for slow changes, caused for instance by heat or settling effects, in the dimensions or position of individual components of the valve assembly that are disposed in the force transmission path. Compensation without transmitting force means that the position of the valve element to be triggered in the valve assembly remains unaffected by such thermal or settling effects. Especially in piezoelectric actuator units, the force transmission chamber typically serves to boost the stroke of the actuator unit, which typically ranges only up to a few tens or hundreds of micrometers.

Unavoidable leakage effects require constantly recurring filling of the force transmission chamber with hydraulic fluid, in order to keep the pressure in the force transmission chamber constant.

### ADVANTAGES OF THE INVENTION

The invention now makes a way available of meeting this requirement for filling at comparatively little production effort and expense. To that end, a valve assembly, in particular for a fuel injection system of an internal combustion engine, including an adjustably disposed valve element, including an actuator unit, in particular piezoelectric, for adjusting the valve element, a hydraulic force transmission chamber, disposed in the force transmission path between the actuator unit and the valve element, and a hydraulic pressure distributor assembly for diverting at least one hydraulic filling stream, to be delivered to the force transmission chamber for filling it, from a hydraulic mainstream. The pressure distributor assembly has a conduit system, embodied in a conduit housing and having a main conduit leading to the hydraulic mainstream and at least one filling conduit, carrying the hydraulic filling stream and branching off from the main conduit, and the pressure distributor assembly—as viewed in the flow direction of the hydraulic mainstream—forms one hydraulic throttling region each, on both sides of the branching point of the filling conduit from the main conduit, for the hydraulic mainstream. At least one of the throttling regions is embodied as a throttle bore.

Even if high precision is required, throttle bores are comparatively simple to make. Embodying at least one of the throttling regions as a throttle bore makes a mutual decoupling of the throttling regions possible, that is, a setting of the throttling behavior of each of the throttling regions independently of one another, without a modification of one of the throttling regions having a direct effect on the throttling behavior of the other throttling region.

When the term throttle bore is used here, it is understood not only in the strictest sense as a circular-cylindrical bore produced by a mechanical drilling tool. On the contrary, a throttle bore should be understood in a broader sense to include other hole-like throttle passages with a cross-sectional shape other than a circle, which moreover can be produced in some other way than mechanical drilling. Laser drilling, for instance, comes to mind, but chemical or electrochemical processes are fundamentally conceivable as well. Moreover, the term “throttle” should be understood here to mean that it encompasses all kinds of flow resistors, from tubular flow resistors in which the flow length is long compared to the mean flow diameter, to baffle-like flow resistors in which the flow length is short compared to the mean flow diameter.

Preferably, at least the throttling region located downstream of the branching point is embodied as a throttle bore. Then the throttling region located upstream of the branching point can also be embodied as a throttle bore. In a first variant, at least one of the throttling regions is formed by a throttle bore, which is embodied in a throttle body produced separately from the conduit housing and retained solidly thereon. The capability of machining the throttle body far away from the conduit housing makes high-precision production of the throttle bore possible. Moreover, it becomes possible in advance to provide a set of throttle bodies with different throttle bores in terms of their throttling behavior. Depending on the desired pressure in the force transmission chamber and/or on the desired flow rate of the hydraulic mainstream downstream of the branching point, a more-suitable throttle body can then be selected from this set. If it is found after the valve assembly has been put together that the throttle body selected still does not lead to the desired results, it can easily be replaced for another throttle body from the set. The production cost for the throttle body can be kept especially low if it is embodied as a flat throttle disk with a central throttle bore.

The throttle body can be inserted into a larger-diameter portion of the main conduit and braced on a transitional step to a smaller-diameter portion of the main conduit. A transitional step of this kind in the main conduit can be produced at comparatively low cost and makes exact positioning of the throttle body possible. The throttle body can be fixed to the transitional step by means of a screw body screwed into the main conduit, and the screw body forms an essentially unthrottled flow passage, preferably forming a central throttle bore, for the hydraulic mainstream. For forming this flow passage, the screw body can in a simple way have a central throttle bore.

To prevent contaminants entrained with the hydraulic mainstream from plugging up the throttling regions, it is recommended that suitable provisions for filtering the hydraulic mainstream be made upstream of the throttling region located upstream of the branching point. In the case of a throttle body that forms the upstream throttling region, a filtering element for filtering the hydraulic mainstream can be retained for this purpose in the main conduit between the screw body and the throttle body. Although it is fundamentally possible to use a sieve body or porous body for the filtering element, a filtering element that is impermeable to the hydraulic fluid will preferably be used, which between its outer circumferential jacket and the conduit wall of the main conduit defines a filter gap, in particular an annular filter gap.

In a second variant, one of the throttling regions, in particular the throttling region located downstream of the branching point, can be formed by a throttle bore machined into the material comprising the conduit housing. For the sake of simple production of the throttle bore, the throttle bore will expediently be located near the outside of a housing body of the conduit housing. For producing the throttle bore, recourse can be had in particular to a laser drilling method.

A third variant provides that one of the throttling regions, in particular the throttling region located downstream of the branching point, is formed by a throttle bore, and that for forming the other throttling region, in particular the throttling region located upstream of the branching point, a throttle pin is inserted into the main conduit, which between its pin jacket and the conduit wall of the main conduit defines a throttle gap.

In this respect, the following must be taken into account: The gap width of the throttle gap can easily be within a range in which production-dictated variations in the shape of the main conduit and/or of the throttle pin can have a major influence on the throttling behavior of the throttle gap. High-precision machining of the main conduit and of the throttle pin is therefore necessary, in order to keep unwanted variations in the throttle gap slight, and to set the width of the throttle gap exactly to a desired value. In particular, it may be necessary to adapt the machining of the main conduit and the machining of the throttle pin to one another. This comparatively major machining effort and expense can be reduced to a tolerable level, however, by providing that only one of the throttling regions is embodied by a throttle pin inserted with guide play into the main conduit.

In that case, the throttle pin can in fact be comparatively short, and in particular so short that it becomes possible to grind the main conduit with the requisite precision. While long conduit portions that have to be ground require a grinding tool with a comparatively long tool shaft, where unavoidable torsion of the tool shaft can cause unacceptably major grinding variations, in the case of a short conduit portion to be ground recourse can be had to a grinding tool with a short tool shaft, in which there is no need to fear such torsion-dictated tolerances—or at least they will be only within a tolerable range.

Because it is possible to assure high production precision of the conduit portion into which the throttle pin is to be inserted, the problem of gap tolerances for the throttle gap is greatly ameliorated. Machining of the throttle pin adapted to any shape tolerances of the main conduit is no longer necessary in that case. All of these means it is possible to reduce the number of diameter and/or length classes that must be kept on hand for the throttle pin to allow the engineer, upon assembly of the valve assembly from this set of throttle pins, to select a suitable throttle pin to enable setting a desired pressure in the force transmission chamber and/or a desired flow rate of the hydraulic mainstream downstream of the branching point.

To facilitate the precise grinding of the main conduit in the case of a branching point located inside the conduit housing, the main conduit in the region of the branching point preferably has a cross-sectional enlargement. When the upstream part of the main conduit, in terms of the branching point, is ground, the grinding tool can then be moved all the way into the free space formed by this cross-sectional enlargement. This makes a uniform removal of material possible from all the parts of the main conduit to be ground. The cross-sectional enlargement can be produced for instance by electrochemical erosion (electrolytic machining).

A preferred refinement of the invention provides that the main conduit is branched off from a fuel supply line that serves to deliver fuel to an injection nozzle of the engine. In this way, a direct dependency of the pressure in the force transmission chamber on the feed pressure of the fuel in the fuel supply line can be attained.

Further advantageous features can be learned from the claims, description and drawings.

### Drawings

In the drawings, three exemplary embodiments of the invention are shown, which are described in further detail in the ensuing description.

FIG. 1 shows one exemplary embodiment of the valve assembly of the invention, with the pressure distributor assembly shown schematically;

FIG. 2 shows a first variant realization of the pressure distributor assembly;

FIG. 3 shows a second variant realization of the pressure distributor assembly; and

FIG. 4 shows a third variant realization of the pressure distributor assembly.

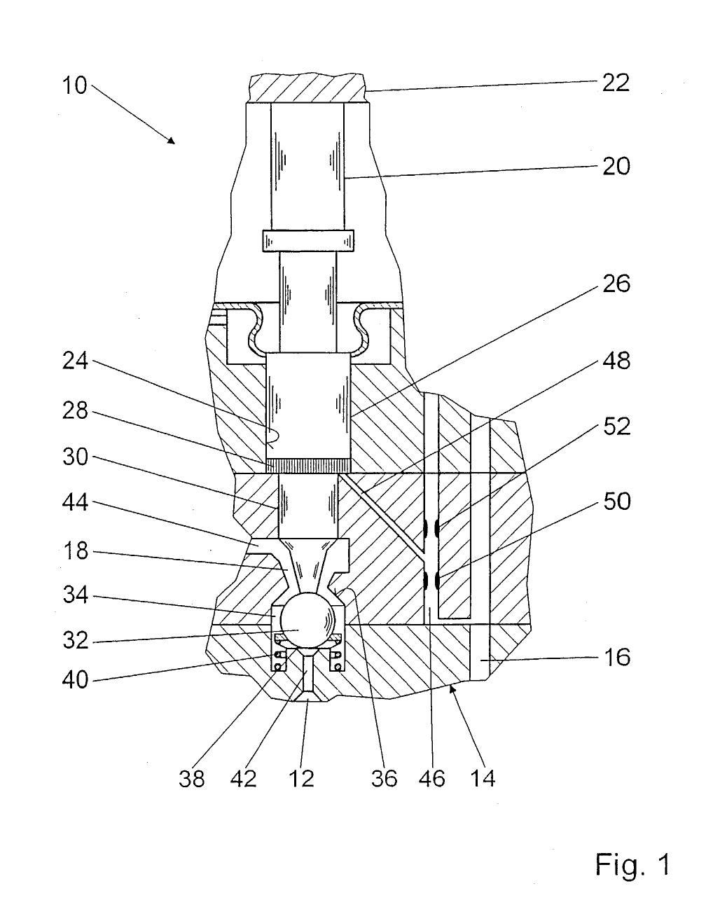

The valve assembly shown in FIG. 1 is part of a Diesel reservoir-type injection system, also known as a common rail injection system, for an internal combustion engine for a motor vehicle. Here the valve assembly is built into an injector module, identified overall by reference numeral 10, which in a manner known per se and therefore not shown in further detail has an injection nozzle protruding into a cylinder combustion chamber of the engine and a nozzle needle that opens and closes the injection nozzle as a function of the pressure in a nozzle control chamber 12. The injector module 10 has a multi-part injector housing 14, in which a fuel supply conduit 16 supplied from a high-pressure distributor or rail is embodied, by way of which conduit the injection nozzle is supplied with fuel. The control chamber 10 is also supplied with fuel from the fuel supply conduit 16 via a supply conduit (not shown) which is embodied in the injector housing 14 and is always open. If a high pressure prevails in the control chamber 12, then the nozzle needle subjected to this pressure closes the injection nozzle. If conversely a relief path 18 connected to the control chamber 12 is opened, then fuel flows out of the control chamber 12. The attendant pressure drop in the control chamber 12 causes the nozzle needle to open the injection nozzle, and fuel is injected into the cylinder combustion chamber. The valve assembly of the invention serves to open or close the relief path 18 selectively and accordingly serves to fix the instant and duration of injection.

The valve assembly includes a piezoelectric valve actuator unit 20, which is controlled by an electronic control unit, not shown, of the injection system and whose reciprocating bodies, preferably formed of many layers of piezoelectric material stacked one on the other, is braced on one end on a support wall 22 of the injector housing 14, while on the other end it acts on a control piston 26 guided displaceably in a larger-diameter portion of a stepped bore 24 of the injector housing 14. The reciprocating motions of the control piston 26 are transmitted, via a hydraulic force transmission chamber 28, to an operative piston 30 guided displaceably in a smaller-diameter portion of the stepped bore 24, which piston is solidly connected to a valve element 32, embodied here as a seat element. The seat element 32 is adjustable in a valve chamber 34 between two opposed valve seats 36, 38 and is prestressed toward the valve seat 36 by a valve spring 40. The relief path 18 extends via the valve chamber 34; it has both an outlet conduit 42, discharging into the valve chamber 34 in the region of the valve seat 38 and communicating with the control chamber 12, which outlet conduit as a rule includes an outlet throttle, not identified by reference numeral here, and also a return conduit 44, which extends out of the valve chamber 34 in the region of the valve seat 36 and in which the fuel that has flowed out of the control chamber 12 returns to a fuel source, from which a high-pressure pump pumps the fuel into the high-pressure distributor.

Because of the difference in diameter between the control piston 26 and the operative piston 30, the force transmission chamber 28 acts as a stroke booster, which steps up the comparatively short strokes of the piezoelectric actuator unit 20 to the comparatively long strokes of the seat element 32. The force transmission chamber 28 furthermore makes it possible to compensate for different thermal expansion behavior within the force transmission change from the actuator unit 20 to the seat element 32; such variable thermal expansion behavior can be caused for instance by a temperature gradient inside the injector module 10 or by different coefficients of thermal expansion of the various components of the injector module 10. Possible settling effects of the materials used in the injector module and their connections can also be compensated for in the force transmission chamber 28, without changing the position of the seat element 32.

The force transmission chamber 28 is filled with fuel from the fuel supply conduit 16. To that end, in the injector housing 14, a branching conduit 46 is embodied, which branches off from the fuel supply conduit 16 and returns to the fuel source. Branching off in turn from the branching conduit 46 is a filling conduit 48, which is likewise embodied in the injector housing 14 and which discharges into the force transmission chamber 28. Viewed in the flow direction longitudinally of the branching conduit 46, one schematically represented throttling region 50 and 52 each is embodied in the branching conduit 46 on both sides of the branching point of the filling conduit 48. The two throttling regions 50, 52 form a pressure distributor assembly, by means of which a desired pressure can be set in the force transmission chamber 28 by division downward of the pressure prevailing in the fuel supply conduit 16. The throttling region 52 located downstream of the branching point serves to set the fuel quantity that returns to the fuel source; this quantity must not exceed a limit dependent on the power of the fuel pump, so that the fuel pump will not be overloaded. In terms of terminology, it should also be noted that the branching conduit 46 will hereinafter also be called the main conduit of the pressure distributor assembly.

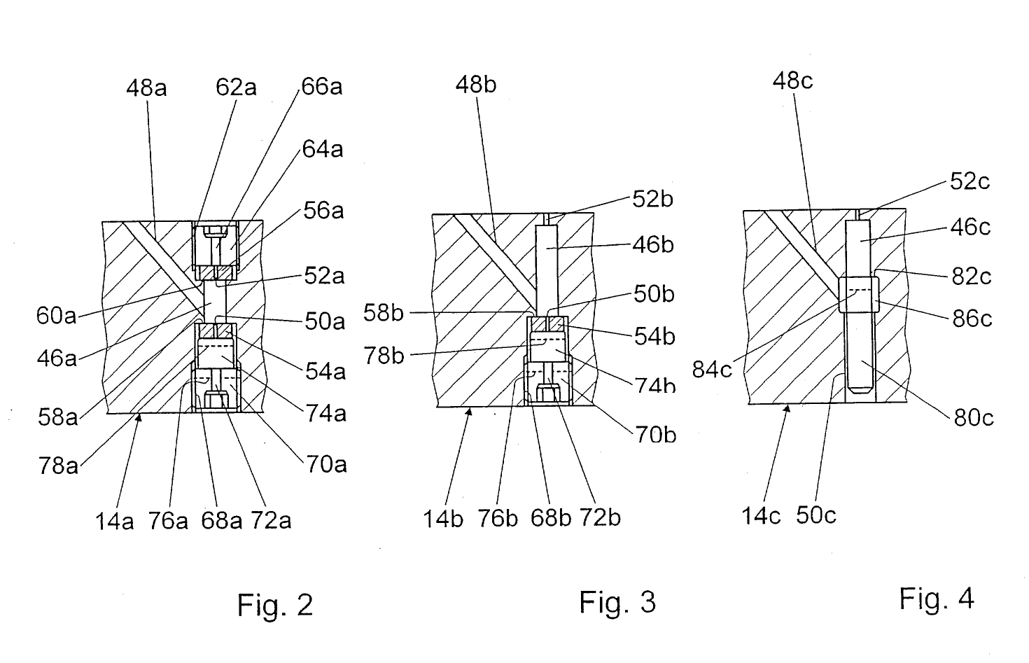

The description now turns to FIGS. 2 through 4. In them, three different variant realizations for the throttling regions 50, 52 are shown. Components that are the same or function the same are identified by the same reference numerals as in FIG. 1, but with a lower-case letter added that varies from one drawing figure to another.

In all three variant realizations of FIGS. 2 through 4, the flow cross section of the downstream throttling region 52 is dimensioned in no case as smaller and preferably is larger than the flow cross section of the upstream throttling region 50. As a result, changes in the flow cross section of the downstream throttling region 52 can be maximally kept from affecting the pressure in the force transmission chamber 28, which pressure can be set essentially solely via the flow cross section of the upstream throttling region 50.

In the variant of FIG. 2, the throttling regions 50a, 52a are each embodied as a throttle bore, which is embodied centrally in a disklike throttle body 54a and 56a, respectively, that is produced separately from the injector housing 14. The two throttle disks 54a, 56a are inserted into the main conduit 46a and each rest on a respective diameter-narrowing annular step 58a and 60a of the main conduit 46a. To meet the aforementioned demand for different flow cross sections of the throttle bores 50a, 52a, the throttle bore 50a in the throttle disk 54a can for instance have a diameter of about 0.06 mm, while the throttle bore 52a in the throttle disk 56a can have a diameter of about 0.1 mm.

The downstream throttle disk 56a is fixed in the main conduit 46a by means of a screw body 64a that is screwed into a female thread 62a of the main conduit 46a. The screw body 64a has a central through bore 66a, which is in coincidence with the throttle bore 52a of the throttle disk 56a and allows the fuel returning to the fuel source to pass through. This through bore 66a of the screw body 64a is dimensioned as large enough that it develops—if any—no throttling effect that plays any significant role.

By means of the same kind of screw body 70a, screwed into a further female thread 68a of the main conduit 46a and having a central through bore 72a, the upstream throttle disk 54a, in terms of the branching point of the filling conduit 48a, is also firmly clamped against the annular step 58a. However, in this case, between the throttle disk 54a and the screw body 70a, a filtering body 74a that is impermeable to the fuel is also inserted; between its outer circumferential jacket and the conduit wall of the main conduit 46a, it defines a filter gap, in particular an annular filter gap. The gap width of this filter gap is dimensioned such that particles contained in the fuel that could stop up the throttle bore 50a of the throttle disk 54a are filtered out. For the diameter given above as an example of about 0.06 mm of the throttle bore 50a, a gap width of about 30 m for the filter gap is recommended. Certainly care must be taken that the filter gap overall offer a flow cross section for the fuel that is substantially larger than the flow cross section of the throttle bore 50a, so that the filter gap itself makes no significant contribution to the upstream throttling action.

To create a communication for the fuel between the through bore 72a of the screw body 70a and the filter gap, the screw body 70a, on its side toward the filtering body 74a, has a transverse groove 76a, represented by dashed lines, that intersects its through bore 72a. Alternatively, it is conceivable to provide such a transverse groove on the side of the filtering body 74a remote from the screw body 70a. A transverse groove 78a, also represented by dashed lines, embodied on the side of the throttle disk 54a in the filtering body 74a creates a communication between the filter gap and the throttle bore 50a.

The variant of FIG. 3 differs from the variant of FIG. 2 in the embodiment of the throttling region 52b located downstream of the branching point of the filling conduit 48b. Although in FIG. 3 this throttling region is again embodied as a throttle bore, nevertheless this throttle bore 52b is machined directly into the material of the injector housing 14b, preferably by laser drilling. Producing the throttle bore 52b proves to comparatively simple if the injector housing 14b is put together from a plurality of separate housing bodies, and if the throttle bore 52b is disposed in the region of the outside of one of these housing bodies.

In the variant of FIG. 4, the throttling region 52c located downstream of the branching point of the filling conduit 48c is, as in FIG. 3, embodied as a throttle bore machined integrally into the material of the injector housing 14c. Unlike FIGS. 2 and 3, however, the upstream throttling region 50c is formed by a throttle gap, which is formed between the outer circumferential jacket of a throttle pin 80c, thrust into the main conduit 46c, and the conduit wall of the main conduit 46c. The flow resistance of this throttle gap can be set by way of the length of the throttle pin 80c and its cross-sectional size. The throttle gap itself can extend annularly around the throttle pin 80c.

Still other cross-sectional shapes of the throttle gap are also conceivable, however, such as crescent-shaped or in the shape of a segment of a circle. For positioning the throttle pin 80c in the direction of its pin axis, the throttle pin 80c can be braced, in the region of its downstream end, on a positioning step 82c of the main conduit 46c; a transverse groove 84c machined into this end of the pin and represented by dashed lines enables the passage of the fuel to the regions of the main conduit 46c that are located downstream of the throttle pin 80c.

In the region of the branching point of the filling conduit 48c, the main conduit 46c has a cleared area 86c, produced by electrolytic machining, which forms a portion of increased cross section of the main conduit 46c. This is the reason for this cleared area 86c: The region of the main conduit 46c located upstream of the branching point of the filling conduit 48c is ground in order to set the throttle gap with precision. The grinding tool employed is introduced into the main conduit 46c here from below the housing body, shown in FIG. 4, of the injector housing 14c. Since the throttle bore 52c prevents allowing the grinding tool to emerge from the main conduit 46c again on the top side of this housing body, the grinding tool must be stopped in its advancement motion inside the housing body and retracted again. This reversal of motion of the grinding tool is now advantageously performed inside the cleared area 86c. Thus the region of the main conduit 46c that adjoins the cleared area 86c upstream of it receives a grinding treatment that is uniform at all points. One additional advantage of the cleared area 86c is that any burrs, created during the electrochemical machining of the material of the injector housing 14c to produce the cleared area, that may have become stuck after the main conduit 46c and/or the filling conduit 48c are drilled are removed.

Because of the comparatively short length of the throttle pin 80c, it is readily possible to grind the main conduit 46c while maintaining the requisite precision. It has been found in practice that a length of the throttle pin 80c that is equal to approximately three times the pin diameter can suffice. For a pin diameter of about 2 mm, for instance, the pin length is then about 6 mm. The shaft of the tool used for the grinding can be correspondingly short. In such short tools, there is essentially no need to fear torsion that would impair the grinding precision. The throttle pin 80c itself can be brought to the requisite precision for instance by so-called bitless through grinding.

The invention is understood to be usable not only in common rail Diesel injectors but in general wherever a pressure distributor function for setting the pressure in a hydraulic chamber is desired, the hydraulic chamber being disposed in the force transmission path between a valve actuator unit and a valve element to be actuated. It is therefore equally clear that the invention is in no way limited to a double-switching valve assembly with two valve seats of the kind described above. Single-switching valve assemblies with only one valve seat are equally conceivable, as are such other valve designs as piston longitudinal slide valves.

1. A valve assembly, in particular for a fuel injection system of an internal combustion engine, including an adjustably disposed valve element (32), including an actuator unit (20), in particular piezoelectric, for adjusting the valve element (32), a hydraulic force transmission chamber (28), disposed in the force transmission path between the actuator unit (20) and the valve element (32), and a hydraulic pressure distributor assembly (50, 52) for diverting at least one hydraulic filling stream, to be delivered to the force transmission chamber (20) for filling it, from a hydraulic mainstream, wherein the pressure distributor assembly (50, 52) has a conduit system (46, 48), embodied in a conduit housing (14) and having a main conduit (46) leading to the hydraulic mainstream and at least one filling conduit (48), carrying the hydraulic filling stream and branching off from the main conduit (46); wherein the pressure distributor assembly (50, 52), viewed in the flow direction of the hydraulic mainstream, forms one hydraulic throttling region (50, 52) each, on both sides of the branching point of the filling conduit (48) from the main conduit (46), for the hydraulic mainstream; and wherein at least one of the throttling regions (50, 52) is embodied as a throttle bore (50a, 52a; 50b, 52b; 52c).

2. The valve assembly of claim 1, characterized in that at least the throttling region (52) located downstream of the branching point is embodied as a throttle bore (52a; 52b; 52c).

3. The valve assembly of claim 2, characterized in that the throttling region (50) located upstream of the branching point is also embodied as a throttle bore (50a; 50b).

4. The valve assembly of one of claims 1-3, characterized in that at least one of the throttling regions (50, 52) is formed by a throttle bore (50a, 52a; 50b), which is embodied in a throttle body (54a, 56a; 54b) produced separately from and retained solidly on the conduit housing (14a; 14b).

5. The valve assembly of claim 4, characterized in that the throttle body (54a, 56a; 54b) is embodied as a flat throttle disk with a central throttle bore (50a, 52a; 50b).

6. The valve assembly of claim 4 or 5, characterized in that the throttle body (54a, 56a; 54b) is inserted into a larger-diameter portion of the main conduit (46a; 46b) and is braced on a transitional step (58a, 60a; 58b) to a smaller-diameter portion of the main conduit (46a; 46b).

7. The valve assembly of claim 6, characterized in that the throttle body (54a, 56a; 54b) is fixed to the transitional step (58a, 60a; 58b) by means of a screw body (64a, 70a; 70b) screwed into the main conduit (46a; 46b), and the screw body (64a, 70a; 70b) forms an essentially unthrottled flow passage, preferably forming a central through bore (66a, 72a; 72b), for the hydraulic mainstream.

8. The valve assembly of claim 7, characterized in that the throttle body (54a; 54b) forms the throttling region located upstream of the branching point, and that a filtering element (74a; 74b) for filtering the hydraulic mainstream is retained in the main conduit (46a; 46b) between the screw body (70a; 70b) and the throttle body (54a; 54b).

9. The valve assembly of claim 8, characterized in that the filtering element (74a; 74b) is impermeable to the hydraulic fluid, and a filter gap, in particular an annular filter gap, is defined between the outer circumferential jacket of the filtering element (74a; 74b) and the conduit wall of the main conduit (46a; 46b).

10. The valve assembly of one of claims 1-9, characterized in that one (52) of the throttling regions (50, 52), in particular the throttling region (52) located downstream of the branching point, is formed by a throttle bore (52b; 52c) machined into the material comprising the conduit housing (14b; 14c).

11. The valve assembly of claim 10, characterized in that the throttle bore (52b; 52c) is disposed near the outside of a housing body of the conduit housing (14b; 14c).

12. The valve assembly of claim 10 or 11, characterized in that the throttle bore (52b; 52c) is produced by laser drilling.

13. The valve assembly of one of claims 1-12, characterized in that one (52) of the throttling regions (50, 52), in particular the throttling region (52) located downstream of the branching point, is formed by a throttle bore (52c), and that for forming the other throttling region (50), in particular the throttling region (50) located upstream of the branching point, a throttle pin (80c) is inserted into the main conduit (46c), which between its pin jacket and the conduit wall of the main conduit (46c) defines a throttle gap.

14. The valve assembly of claim 13, characterized in that the branching point is disposed inside the conduit housing (14c), and in the region of the branching point the main conduit (46c) has a cross-sectional enlargement (86c), the cross-sectional enlargement (86c) preferably being produced by electrochemical erosion.

15. The valve assembly of one of claims 1-14, characterized in that the main conduit (46) branches off from a fuel supply line (16) that serves to deliver fuel to an injection nozzle of the engine.
